(19) United States
(12) Patent Application Publication
(10) Pub. No.: US 2014/0195198 A1
(43) Pub. Date: Jul. 10, 2014

(54) AGGREGATING AND PROCESSING DISTRIBUTED DATA ON ULTRA-VIOLET (UV) EXPOSURE MEASUREMENT

(71) Applicants: Ehud Reshef, Kiryat Tivon (IL); Sumeet Sandhu, Santa Clara, CA (US); Songnan Yang, San Jose, CA (US); Kelly Hoffman, North Plains, OR (US); Kristoffer Fleming, Chandler, AZ (US); Hossein Alavi, Portland, OR (US)

(72) Inventors: Ehud Reshef, Kiryat Tivon (IL); Sumeet Sandhu, Santa Clara, CA (US); Songnan Yang, San Jose, CA (US); Kelly Hoffman, North Plains, OR (US); Kristoffer Fleming, Chandler, AZ (US); Hossein Alavi, Portland, OR (US)

(21) Appl. No.: 13/738,472

(22) Filed: Jan. 10, 2013

(51) Int. Cl. G01J 1/44; G06F 17/00

(52) U.S. Cl. CPC G01J 1/44; G06F 17/00
USPC 702/188

(57) ABSTRACT

The present application discloses devices, systems and methods for establishing and utilizing a UV sensing network to harness the efficacy of distributed UV sensing to produce improved accuracy of UV exposure measurement using mobile devices. This may be accomplished by “crowd sourcing”, i.e. having multiple devices work collaboratively to measure the UV exposure. The collaboration can be implemented in many potential ways, such as, using a server based architecture where devices connect to a specific “UV measurements server” to provide measurements and receive aggregate estimated exposure levels, and/or by using a peer-to-peer architecture, where devices in a specific region creates a local ad-hoc UV sensing network.

### TECHNICAL FIELD

This disclosure relates generally to the field of use of mobile devices for situational awareness applications, such as ultra-violet (UV) radiation sensing. Specifically, the disclosure relates to aggregating UV sensing data from multiple mobile devices to produce accurate UV exposure measurement and/or other related contextual information.

### BACKGROUND ART

With global warming, dwindling ozone levels, and increasing radiation from the Sun reaching the earth, the dangers of UV exposure are on the rise. It is well known that while moderate amount of UV exposure is beneficial (as UV radiation helps in production of vitamin D, melanin etc.), overexposure to UV radiation can potentially cause health problems, starting from erythema, i.e., redness of skin, indicating skin damage, to severe health hazards, such as skin cancer, genetic mutations etc. Medical data shows that skin cancer caused by UV from sunlight is one of the prevalent forms of cancer in the United States and worldwide. In addition to posing health hazard to human beings and other living things (e.g. animals, plants), overexposure to UV may cause damages to equipment/gadgets as well, or at least cause them to malfunction when used or kept outdoors. Therefore, there is a clear need for UV exposure meters which gather UV exposure data from UV sensors coupled to the exposure meters.

Various commercial UV sensors are available currently. A popular form of UV exposure meter comprises sensors mounted on wearable accessories, such as wrist/arm bands, watches, belts, jewelry, clothing etc. Smartphone/mobile device accessories, such as, add-on device jackets with UV sensors, have also been introduced recently. These accessories communicate UV measurement data to mobile devices like smartphones, tablets, notebooks, laptops etc. for further processing of data and/or displaying the results to the user.

As mobile devices like smartphones, tablets, notebooks etc. become the device of choice not just for communications, entertainment, data consumption, electronic commerce etc., but also for health and fitness monitoring, it makes sense to integrate local sensors for detection of UV radiation into the mobile devices functionally and/or structurally. An objective of the present disclosure is to provide ways to quantify UV radiation exposure level and/or provide appropriate notifications. Some existing references, such as U.S. Pat. No. 7,526,280, entitled “Service implementing method and apparatus based on an ultraviolet index in a mobile terminal,” focus on using smartphones for UV detection service, but do not provide any detail of how measurement accuracy can be enhanced by utilizing and aggregating distributed data from multiple mobile terminals, each having their own respective UV sensing components.

### SUMMARY

The present application discloses devices, systems and methods for establishing and utilizing a UV sensing network to harness the efficacy of distributed UV sensing to produce improved accuracy of UV exposure measurement using mobile devices. Individual mobile devices with UV sensors may be constrained by device orientation and or other factors, such as whether the device is indoors/outdoors/partially occluded from the UV radiation source that can affect the sensitivity and accuracy of UV data measurement. This problem can be largely obviated by aggregating data from multiple UV sensors coupled to multiple mobile devices connected through a UV sensing network. This collaborative UV measurement scheme may be accomplished by “crowd-sourcing.” The collaboration can be implemented in many potential ways, such as, using a server based architecture where devices connect to a specific UV measurements server to provide measurements and receive aggregate estimated exposure levels, and/or by using a peer-to-peer architecture, where devices in a specific region creates a local ad-hoc UV sensing network.

These and other aspects of the present disclosure will now be described by way of example with reference to the detailed disclosure and the accompanying figures.

### BRIEF DESCRIPTION OF THE DRAWINGS

FIG. 1 depicts a high-level functional block diagram of a UV sensor wirelessly coupled with a mobile device connected to servers, in accordance with aspects of the present disclosure.

FIGS. 2A-2C depict example embodiments of the present disclosure showing various UV sensing network configurations.

FIG. 3 depicts a high-level functional block diagram of a mobile device coupled to a UV sensor, in accordance with various aspects of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

Since mobile devices are carried by users for communication, entertainment, computing, information gathering, electronic transaction or other purposes anyway, additional functional integration, such as UV sensing to the existing mobile electronic devices makes sense as an alternative to having to carry a separate gadget only for UV-sensing.

It is to be noted that UV detection with mobile devices would be most effective when the sensors are exposed to the environment in which the UV radiation is being measured. If a user is indoors, UV detection may not be very essential except for reflected UV. Even when the user himself/herself is outdoors, if the mobile device is inside a pocket, purse or other enclosure, then local measurement by an individual mobile device may not be able to provide accurate data. When an enclosure is detected (for example, by comparing actual readings to what is expected based on the time of day and/or historical data at or near the detected location, or by estimating visible light received) a mobile device may be enabled to find alternative data sources.

The alternative data source may be a server that can be accessed via internet or other networks. The alternative data source may also comprise UV sensors detected nearby, such as other UV accessories worn by the user (watch, wrist/arm/neck/head sensors, etc.) or another person nearby, or other mobile devices carried by other persons within a finite distance. In other words, multiple devices communicating with each other may constitute a UV sensing network so that more accurate UV measurement can be performed by aggregating data from other devices within the network and processing collective UV data. Data transmission between devices may occur over wireless or wired connectors such as Bluetooth, Zigbee, WiFi, cables etc.

For communicating with other in-network mobile devices with UV sensors, a communication module in each mobile device may include an UV interface which comprises transceiver, transponder, modulation/demodulation, and memory circuitry, configured to wirelessly communicate and transmit/receive information, via signal at the appropriate wavelength, upon establishing an UV network communication link. Moreover, though not discussed in detail here, persons skilled in the art will appreciate, in view of the present disclosure, that upon establishing the communication link, UV interface may initiate launching of UV data processing management logic/application which facilitates the ultimate goal of delivering accurate UV measurement data and other contextual information/alerts to users.

By “crowd sourcing” UV measurements from multiple users and devices in a collaborative manner, the sensitivity to specific device constraints, such as, orientation of the UV sensor with respect to the UV source, and, exposure of the UV sensor (i.e., whether the device is indoors/outdoors/partially occluded etc.) to the UV source, can be reduced to a perceptible extent. Moreover, distributed UV sensing makes it possible to harvest UV energy from multiple mobile devices using specialized photovoltaic cells/sensors that can provide corollary benefits, such as, charging the device battery pack. The corollary functionalities can be performed while indicating UV specific exposure levels, or even when the UV sensing functionality is not being used.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

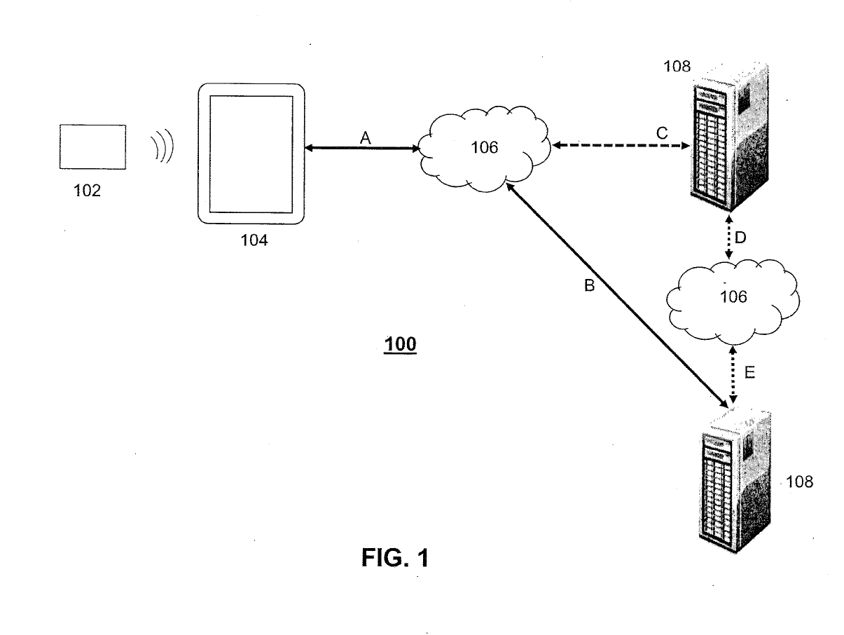

FIG. 1 depicts a high-level functional block diagram of a UV sensing network system 100 for producing accurate UV exposure measurement, in accordance with various aspects of the present disclosure. As illustrated, system 100 includes one or more UV sensor(s) 102, electronic device 104 having communication capabilities with the UV sensor 102, and at least one server 108.

In the embodiment depicted in FIG. 1, UV sensor 102 is in the form of a sensor that is a standalone sensing device, or a physically detachable portion of the device 104. For example, standalone sensor 102 may be a UV measurement patch or wearable article (such as, a hat, a wristband; sunglasses etc. with a UN sensor built into it). Sensor 102 may directly communicate with server 108 if a communication circuit is included in the sensor 102. Sensor 102 may also take the form of a sticker, banner, key fob, or other suitable media, consistent with the disclosed embodiments. Device 104 may be configured to energize sensor 102, establish a communication link with sensor 102, and read UV sensing data from sensor 102. Device 104 may represent any of a number of electronic and/or computing devices, both wireless and wired. For example, device 104 may comprise desktops, laptops, mobile devices, smart phones, gaming devices, tablet computers, etc. Persons skilled in the art will also appreciate that though in FIG. 1, sensor 102 is shown as external to the device 104, sensor 102 may actually be integrated with device 104, and can be optionally detached from the device 104. Examples of intergarted UV sensors and UV sensors physically detachable from the host device 104 can be found in co-pending co-owned application Ser. No. 13/630,661 to Sandhu et al., entitled, “Mobile Device-Based Ultra-Violet (UV) Radiation Sensing.”

Device 104 may be coupled to a server 108 via a network 106. For example, device 104 and one of the servers 108 may be communicatively coupled through bi-directional communication channels A and B shown in FIG. 1. Server 108 may be a dedicated UV data processing server, or a multi-function server having a UV data processing portion. Example of a server 108 may be a server hosting publicly available UV measurement data, such as servers maintained by government organizations (such as the Environmental Protection Agency (EPA)), or other private/public entities. Data hosted in server 108 can be accessed by device 104 to Supplement and/or analyze data collected by local sensor 102. Data collected by local sensor 102 may be processed by device 104 locally or sent to server 108 for further processing. Each server 108 may receive data from multiple devices 104 to generate aggregate distributed UV measurement data Multiple devices in collaboration may be using local peer-to-peer (P2P networks, or may process data over the “Cloud.” The cloud might be designed out of a single centralized server, a set of hierarchically connected servers, a plurality of distributed region specific servers, or any combination thereof. The bi-directional arrows C, D and E are showing possible communication channels between various components in the cloud. Persons skilled in the art will appreciate that servers 108 may be physical servers or virtual instances of servers in the cloud.

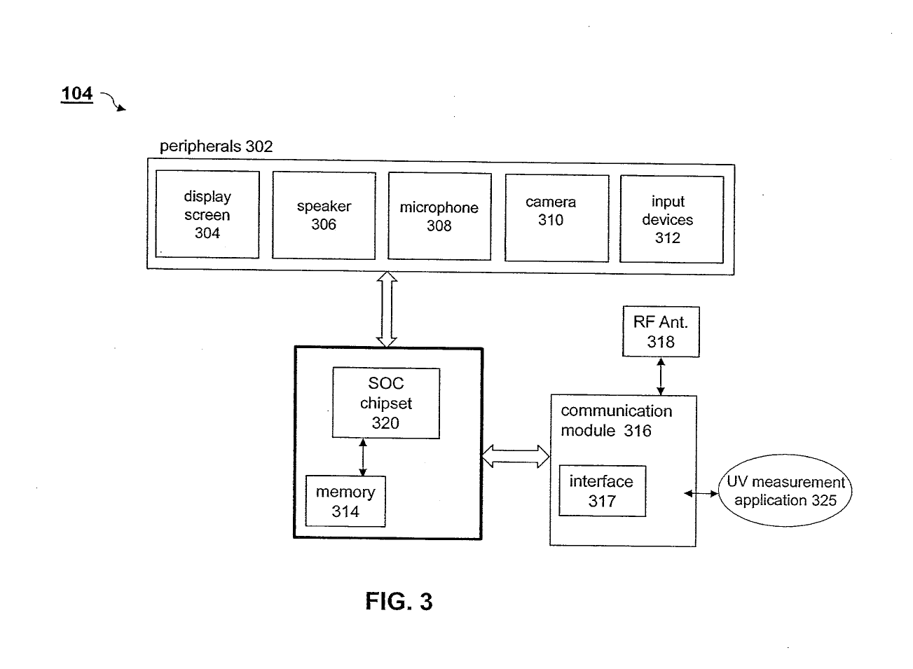

Persons skilled in the art will appreciate in view of the present disclosure that an important aspect regarding UV exposure may not just be the exposure to current/instantaneous UV radiation levels, but an overall (integrative) radiation level over a specific temporal window, and the device 104 and/or server 108 may have integration modules (though not specifically shown in FIG. 1 or FIG. 3, that shows components of device 104 in greater detail).

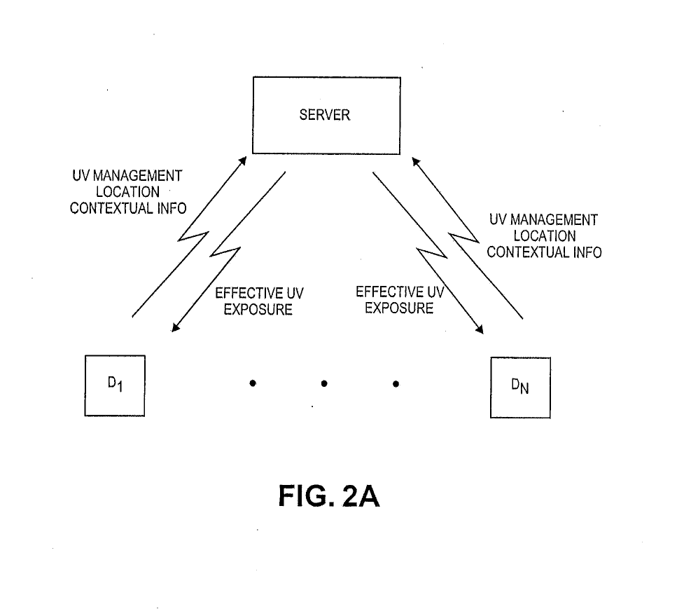

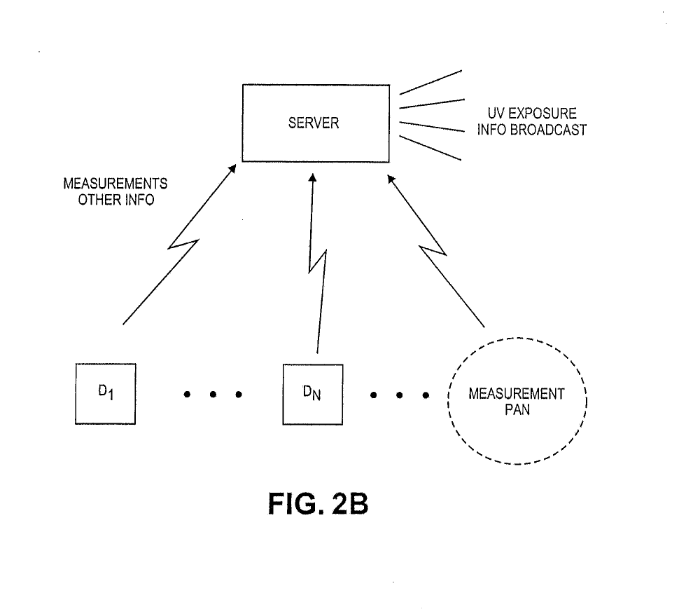

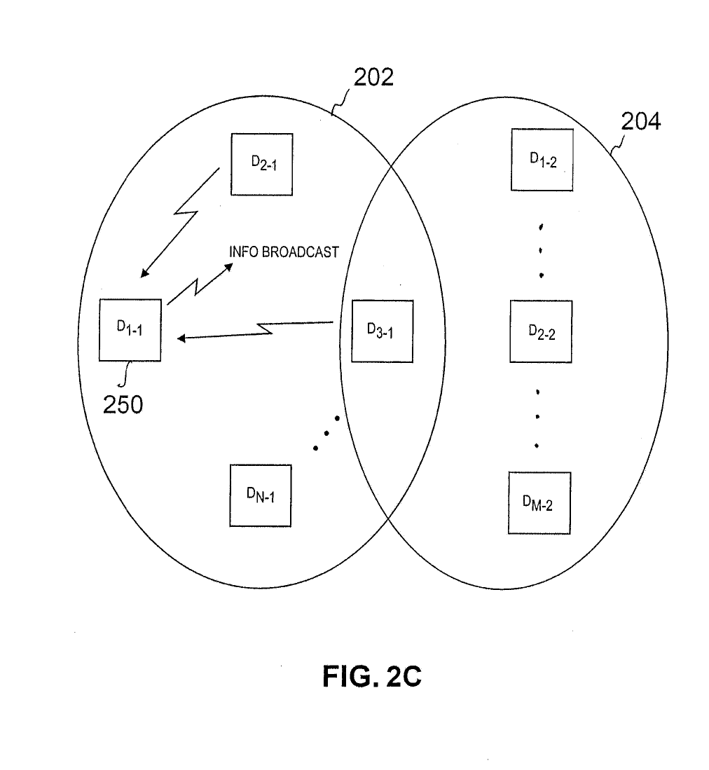

FIGS. 2A-2C depict example embodiments of the present disclosure showing various UV sensing network configurations. As mentioned above, the crowd-sourcing aspect of the present disclosure, where multiple devices work collaboratively to measure accurate UV exposure. The collaboration can be accomplished in many potential ways, such as, using a server based architecture where devices connect to a specific UV measurements server to provide measurements and receive aggregate estimated exposure levels, and/or by using a peer-to-peer (P2P) architecture, where devices in a specific region creates a local ad-hoc UV sensing network.

FIG. 2A shows individual devices D₁, . . . , D_{N}, each directly communicating to a central UV server, sending UV measurement data and/or other related information to the server. The related information may include, but are not limited to, location information, contextual information (such as whether the individual device is indoors/outdoors, or otherwise in an environment where exposure to the UV radiation source is blocked). More refined contextual information may include whether the device is in a pocket/pouch, whether the device is at an orientation and/or elevation where exposure to the Sun is non-optimum/minimal/non-existent etc., whether the device is in use, the current status of battery life etc. The server processes information received from the individual devices, calculates the effective UV exposure from the aggregated data, and sends the information back to the individual devices. In this configuration, the individual devices D₁, . . . , D_{N} do not necessarily form a short-range network among themselves, but still act collaboratively by communicating with a common server.

FIG. 2B shows another configuration where individual devices D₁, . . . , D_{N} communicate independently with a common server, similar to what is shown in FIG. 2A. However, the additional component in the configuration shown in FIG. 2B is a personal area network (PAN) shown with the dotted line, that may comprise multiple UV sensors communicating with a single device (or multiple in-network devices communicating among themselves) and generating a PAN-specific aggregated data, which is then communicated to the common server for the next layer of aggregation with data received from devices outside of the PAN. In the example shown in FIG. 2B, instead of communicating back the aggregated data only to the devices and the PAN through narrow-cast, the server broadcasts the effective UV exposure information for the benefit of other devices within the broader UV sensing network, which may not have their own UV sensors, or whose UV sensing capabilities are temporarily compromised.

FIG. 2C shows another configuration where no central server per se is used. Rather the internal processing power of an in-network device 250 is used as a server which broadcasts/selectively narrow-casts effective UV measurement data. Device 250 may be part of a measurement sub-network (also referred to as a “loop”) 202. Loop 202 denotes a first loop which may comprise devices D₁₋₁, . . . , D_{N-1}, where the subscript is in the format “device number-loop number.” Loop 204 denotes a second loop which may comprise devices D₁₋₂, . . . , D_{M-2}, as well as device D₃₋₁. In other words, the device D₃₋₁ is part of both the first and the second loops. In the illustrative example shown in FIG. 2C, device D₃₋₁ communicates the aggregated data from both the loops 202 and 204 to the device 250 (D₁₋₁) acting as a “server” for further data aggregation. Devices within a loop may selectively communicate exclusively among themselves rather than communicating only as part of the loop, as shown by the communication arrow between D₁₋₁ and D₂₋₁. Persons skilled in the art would also appreciate that the role of “server” does not have to be played by a specific device, and can be shifted to other devices depending on “context.” For example, if a particular device's processing power is occupied performing alternative functionalities, the UV data processing task may be shifted to a “relatively idle” device in the greater UV processing network on an ad-hoc basis.

Taking into account the overall solution architecture chosen, the aggregate UV exposure information relevant to each region can be reported back to the devices in multiple ways. For examples, each device may advertise its self-measurement and/or an aggregate measurement it has computed locally based on advertisements of other devices in a P2P configuration. The aggregate UV exposure information may also be reported back as a response form the server providing best estimated current UV exposure levels relevant to the device as calculated based on its reported location and/or other information, in a client/server configuration.

The ‘broadcast’ message from a server/device may comprise some sort of alert message when overexposure is detected, or can just be informational, i.e. indicating the level of exposure. Broadcast message can also take several forms. For example, cellular network broadcast messages might be tower specific, tower group specific, network location area specific, etc. Broadcast on a side-band channel of an existing public broadcast service, such as TV, Radio (e.g. similar to traffic alert) is another possibility. Depending on the specific need/configuration, the broadcast message may be with or without extra location-relevant information. Broadcast message can also is delivered as a web feed, e.g. part of the services provided by a weather channel.

An application or platform middleware may be an effective way for combining the UV exposure measurements with relevant contextual information to generate “alerts” or present information in a user-friendly manner. The application or middleware should be integrated at the individual device level.

FIG. 3 illustrates a high-level functional block diagram of UV-sensing-enabled electronic device 104, in accordance with various aspects of the present disclosure. In the illustrative example, UV-sensing-enabled electronic device 104 includes a variety of peripherals, such as, for example, display screen 304, speaker 306, microphone 308, camera 310, input devices 312, as well as memory 314, communication module 316, antenna 318, and a system-on-chip (SoC) chipset 320 for UV data processing. UV sensing-enabled electronic device 104 may also include a bus infrastructure and/or other interconnection means to connect and communicate information between various components of device 104.

In certain example configurations, UV sensing components, such as photodiodes may be integrated with a core SoC included in the internal circuitry of a mobile device. Placing photodiodes only on the SoC may be an economic solution, because standard semiconductor manufacturing techniques may be used to integrate the photodiodes with the SoC, though it may pose constraints on design of the housing, because the SoC needs to be aligned to a transparent window, or internal optical components may be necessary to direct light onto the photodiode integrated with the SoC. Also footprint of the SoC itself becomes larger.

In some embodiments, the SoC may be part of a core processing or computing unit of UV-sensing-enabled electronic device 104, and is configured to receive and process input data and instructions, provide output and/or control other components of device 104 in accordance with embodiments of the present disclosure. Such a SoC is referred to as core SoC. The SoC may include a microprocessor, a memory controller, a memory and other components. The microprocessor may further include a cache memory (e.g., SRAM), which along with the memory of the SoC may be part of a memory hierarchy to store instructions and data. The microprocessor may also include one or more logic modules such as a field programmable gate array (FPGA) or other logic array. Communication between the SoC microprocessor and memory may be facilitated by the memory controller (or chipset), which may also facilitate communication with other peripheral components. The advantage of putting photodiode in the core SoC itself is that UV data processing can be accomplished locally at the core SoC at a very fast speed. Alternatively, the photodiode may be part of a separate chip, which communicates with core SoC.

As understood by persons skilled in the art, the UV data processing functionality can be easily integrated with the computational and storage (memory) elements already existing in a smart mobile device. The memory of UV-sensing-enabled electronic device 104 may be a dynamic storage device coupled to the bus infrastructure and configured to store information, instructions, and programs, to be executed by processors of the SoC and/or other processors (or controllers) associated with device 104. Some of all of memory may be implemented as Dual In-line Memory Modules (DIMMs), and may be one or more of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDECSRAM, PCIOO SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device. Device 104 may also include read only memory (ROM) and/or other static storage devices coupled to the bus infrastructure and configured to store static information and instructions for processors of SoC and/or other processors (or controllers) associated with device 104.

Communication module 316 includes wireless interface 317 which may comprise transceiver, transponder, modulation/demodulation, and memory circuitry, configured to wirelessly communicate and transmit/receive information, via the generated RF signal, upon establishing a wireless communication link with sensor 102. Moreover, upon establishing the communication link, interface 317 may initiate the launching of UV measurement management logic/application 325 which facilitates processing of UV data and/or presenting the measurement results (and other contextual information) to the user.

Quantified results are presented to the user on the display screen 304. A warning message may also be displayed if unsafe exposure levels are determined. Persons skilled in the art will appreciate that the quantified results may be presented in graphical form (e.g., color bars/histograms etc. with or without numerical data) in a user-friendly manner. For example, overexposure may be indicated as ‘red’, when safe exposure may be indicated as ‘green’, while intermediate color codes indicating various levels of exposure so that the user may make an informed decision.

It will be apparent to those skilled in the art after reading this detailed disclosure that the foregoing detailed disclosure is intended to be presented by way of example only and is not limiting. For example, though the disclosure often mentions health monitoring as the illustrative area of application, UV sensors and associated circuitry discussed herein may be applicable in others areas, including, but not limited to, security, forensics, astronomy, pest control, sanitary compliance, air/water purification, authentication, chemical markers, fire detection, reading illegible papyri and manuscripts, etc. Having local UV radiation measurement/awareness can be utilized as input to build smart buildings, smart cars etc. For example, if excess UV radiation level is detected, ‘smart windows’ in smart buildings and/or smart cars may be activated automatically to improve overall wellness of the occupants. This may be done by activating a UV-absorbing screen/shade.

Various alterations, improvements, and modifications of the systems and embodiments may occur and are intended for those skilled in the art, though not expressly stated herein. These alterations, improvements, and modifications are intended to be suggested by this disclosure, and are within the spirit and scope of the exemplary aspects of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of method, processing elements, or sequences, or the use of numbers, letters, or other designations therefore, is not intended to limit the claimed, processes and methods to any order except as can be specified in the claims. Although the above disclosure discusses through various examples what is currently considered to be a variety of useful aspects of the disclosure, it is to be understood that such detail is solely for that purpose, and that the appended claims are not limited to the disclosed aspects, but, on the contrary, are intended to cover modifications and equivalent arrangements that are within the spirit and scope of the disclosed aspects.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the appended claims are hereby expressly incorporated into this detailed description.

1. A network for collaborative measurement of ultra-violet (UV) radiation exposure, the network comprising:
at least one sensor configured to collect data indicating a level of local UV radiation from an environment having UV radiation present therein;
at least one mobile electronic device communicatively coupled to the at least one sensor to receive the collected data indicating the level of local UV radiation; and
a server receiving the collected data indicating the level of local UV radiation, analyzing the collected data, and producing a UV radiation exposure measurement result with improved accuracy.

2. The network of claim 1, wherein while analyzing the collected data, the server combines the collected data indicating the level of local UV radiation with additional contextual information to produce the UV radiation exposure measurement result with improved accuracy.

3. The network of claim 2, wherein the additional contextual information includes one or more of: location information, indication of whether the sensor collecting local UV radiation data is indoors or outdoors, indication of whether the sensor collecting local UV radiation data is partially or fully occluded, an orientation of the sensor, and an elevation of the sensor.

4. The network of claim 1, wherein the server communicates the UV radiation exposure measurement result by broadcasting.

5. The network of claim 4, wherein the broadcasting comprises utilizing one or more of: a cellular network, a side-band channel of a public media transmission network, and web-based feed.

6. The network of claim 1, wherein the server communicates the UV radiation exposure measurement result by selective narrow-casting to mobile electronic devices within the network.

7. The network of claim 1, wherein the UV radiation exposure measurement result is used to generate an alert message if the exposure level is beyond a predefined safe exposure threshold.

8. The network of claim 1, wherein the server is a dedicated UV measurement server coupled to the at least one mobile device via a client-server architecture.

9. The network of claim 8, wherein the dedicated UV measurement server is part of a cloud network.

10. The network of claim 1, wherein the server comprises internal processing circuitry of a second mobile electronic device included in the network.

11. The network of claim 10, wherein the second mobile electronic device is coupled to the at least one mobile electronic device via a peer-to-peer architecture.

12. The network of claim 11, wherein the peer-to-peer architecture is used to establish a personal area network (PAN).

13. The network of claim 12, wherein PAN produces an aggregated UV exposure measurement utilizing data collected from multiple devices within the PAN.

14. The network of claim 13, wherein PAN produces an aggregated UV exposure measurement utilizing data collected from multiple devices within the PAN.

15. The network of claim 13, wherein the network further comprises:
a second dedicated UV server that receives the aggregated UV exposure measurement data from the PAN.

16. The network of claim 15, wherein the second dedicated UV server combines the aggregated UV exposure measurement data from the PAN with data collected by devices outside of the PAN to improve accuracy of UV radiation exposure measurement.

17. A method for collaborative measurement of ultra-violet (UV) radiation exposure, the method comprising:
collecting data indicating a level of local UV radiation from an environment having UV radiation present therein using at least one UV sensor;
receiving data collected by the at least one UV sensor at least mobile electronic device communicatively coupled to the at least one sensor;
receiving the collected data at a server;
analyzing the collected data at the server; and
producing a UV radiation exposure measurement result with improved accuracy.

18. The method of claim 1, wherein the step of analyzing the collected data further comprises:
combining the collected data indicating the level of local UV radiation with additional contextual information to produce the UV radiation exposure measurement result with improved accuracy.

19. The method of claim 1, wherein the collaborative measurement of UV radiation exposure is implemented using a client-server architecture.

20. The method of claim 1, wherein the collaborative measurement of UV radiation exposure is implemented using a peer-to-peer architecture, where a mobile electronic device within a personal area network acts as the server.
